(19) United States
(12) Patent Application Publication
(10) Pub. No.: US 2001/0004973 A1
(43) Pub. Date: Jun. 28, 2001

(54) Device for separating sawdust and manure

(76) Inventor: Nobumasa Asakawa, Shizuoka-ken (JP)

Correspondence Address: Brown Raysman Millstein Felder & Steiner LLP, 120 West 45th Street, New York, NY, 10036, US

(21) Appl. No.: 09/725,700

(22) Filed: Nov. 29, 2000

(30) Foreign Application Priority Data
Dec. 15, 1999 (JP) 11-355238

(51) Int. Cl. B07B 1/34

(52) U.S. Cl. 209/326; 209/366.5

(57) ABSTRACT

A device for separating sawdust and manure, wherein a reticulated object is attached in an inclining condition to a supporting frame through a spring so as to be able to vibrate freely, wherein the reticulated object is vibrated by a vibrating means, wherein sawdust containing manure is placed on the reticulated object, and wherein the reticulated object in an inclining condition is vibrated so that the manure falls from the lower end of the reticulated object and the sawdust passes through the reticulated object and falls beneath the reticulated object.

### BACKGROUND OF THE INVENTION

The invention disclosed herein relates generally to device for separating sawdust and manure. In the claims and specification of the present invention, “manure” refers to the fecal matter of domesticated animals such as horses.

Sawdust is often placed on the floors of sheds such as stables, for domesticated animals. Domesticated animals, such as horses, in the sheds excrete on said sawdust. The present invention relates to a device for separating sawdust and manure, which is used for recycling sawdust by removing manure.

Manure is usually separated from sawdust manually, by scooping sawdust containing manure using a pitchfork or sieve, and shaking it.

The following problems exist in manually separating sawdust and manure.

1. Manual separation of manure and sawdust is time-consuming and burdensome.

2. Manual separation of manure and sawdust is a hard labor that often causes lower back pain in the laborer. It is also a psychologically burdening work.

3. Because it is difficult to differentiate manure from sawdust by visual inspection, it is often impossible to separate the two adequately. Therefore, either sawdust containing manure is reused, or a large amount of sawdust is discarded together with manure. Reuse of sawdust containing manure is unsanitary, while disposal of a large amount of sawdust with manure is uneconomical.

The purpose of the present invention is to solve the above problems by devising a mechanical means of separating sawdust and manure.

### SUMMARY OF THE INVENTION

The present invention provides the following device for separating sawdust and manure.

(1) A device for separating sawdust and manure, wherein a reticulated object is attached in an inclining condition to a supporting frame through a spring so as to be able to vibrate freely, wherein the reticulated object is vibrated by a vibrating means, wherein sawdust containing manure is placed on the reticulated object, and wherein the reticulated object in an inclining condition is vibrated so that the manure falls from the lower end of the reticulated object and the sawdust passes through the reticulated object and falls beneath the reticulated object.

(2) Wheels are attached to said supporting frame for moving.

(3) Said vibrating means is a set of weights attached eccentrically to the shaft of a motor.

(4) An inclined plate is disposed beneath said reticulated object so as to receive the sawdust passing through the reticulated object.

When manure is to be separated from sawdust using the device of the present invention, the sawdust containing manure is placed in the reticulated object. The sawdust in the reticulated object is then moved up and down on the reticulated object because the vibrating means vibrates the reticulated object, which is attached to a supporting frame via a spring so as to be able to vibrate freely. Because the manure is much larger and heavier than the sawdust, while it moves up and down on the reticulated object, it eventually falls to the lower end of the reticulated object in an inclining condition as the reticulated object is rotated. Because the sawdust is much smaller and lighter than the manure, it falls through the holes in the reticulated object toward beneath the reticulated object. In other words, the sawdust is separated from the manure because the manure falls to an end of the reticulated object as the sawdust falls directly beneath the reticulated object.

The separation of sawdust and manure takes much less time because the sawdust and manure separation process is mechanized. The mechanization of the separation of sawdust and manure is also much less taxing physically and psychologically. Because manure is completely removed from sawdust, sawdust containing manure is not reused and manure-free sawdust is not discarded together with manure. Thus, because sawdust containing manure is not reused, it is more sanitary. Also, it is more economical since larger amounts of sawdust are reused.

Since wheels are attached to the supporting frame of the device of the present invention, the device can be easily moved to the desired location.

A set of weights attached eccentrically to the shaft of a motor shakes the motor vigorously while in operation. Therefore, the reticulating object is vibrated at a desired level by the vibrating means consisting of a set of weights attached eccentrically to the shaft of the motor. This mechanism is effective and inexpensive.

The sawdust falling through the holes in the reticulated object is placed on an inclined plate located beneath the reticulated object, then it moves down along said inclined plate, then said sawdust is collected in a desired location. As a result, collection of sawdust is easy and economical.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a perspective view of an embodiment of the device for separating sawdust and manure according to the present invention;

FIG. 2 is a sectional view of the device for separating sawdust and manure of FIG. 1;

FIG. 3 is a sectional view of another embodiment of the device for separating sawdust and manure of the present invention; and

FIG. 4 is a sectional view of an embodiment of the vibrating means of the present invention.

### DETAILED DESCRIPTION OF THE PREFERRED EMBODIMENTS

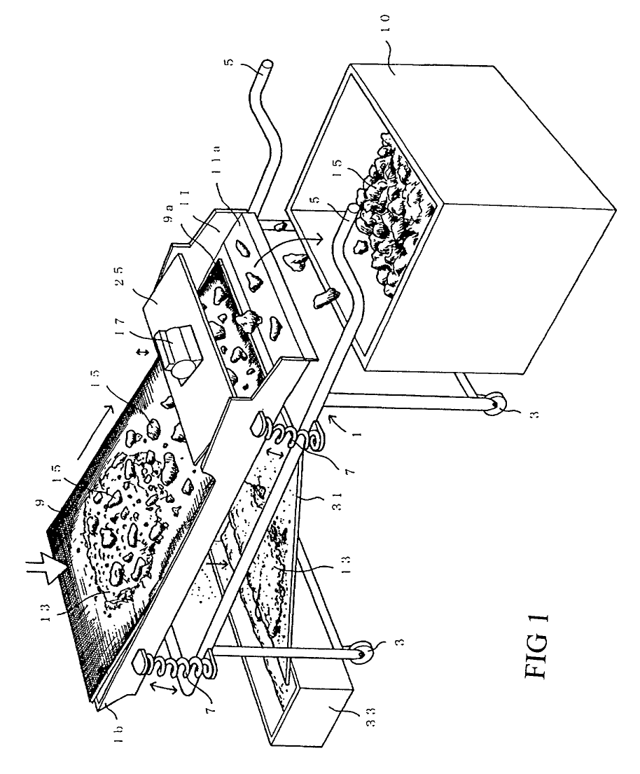

Referring to FIGS. 1-3, 1 denotes a supporting frame of a device for separating sawdust and manure. In the embodiment shown in the drawings, a wheel 3 for moving is attached to the bottom of the supporting frame 1, and a handle 5 is attached to the supporting frame 1 at a position where it is easy to grasp.

A reticulated object 9 is attached in an inclining condition to the supporting frame 1 through a spring 7 so as to be able to vibrate freely. In other words, the reticulated object 9 is connected to the supporting frame 1 through the spring 7. In the embodiment shown in the drawings, the reticulated object 9 is secured within a reticulated object receiving frame 11 in an inclining condition so that the handle 5 is lower, and the reticulated object receiving frame 11 is connected to the supporting frame 1 only through the spring 7. The reticulated object 9 includes a net, such as metal gauze, with holes large enough to allow sawdust 13 to pass through while 1 small enough to prevent manure 15 from passing through.

By vibrating the reticulated object 9 using a vibrating means 17, and vibrating the sawdust 13 containing manure 15 on the reticulated object 9, while the manure 15 moves on the reticulated object 9 in an inclining condition it eventually falls from a lower end 9a of the reticulated object 9, and the sawdust 13 passes through holes of the reticulated object 9 and falls beneath the reticulated object 9. Here, 10 denotes a manure receiving container for receiving the manure 15 that has fallen from the lower end 9a of the reticulated object 9. In the present specification including the scope of the claims, the “lower end of the reticulating object” includes a corresponding end (11a) of the reticulated object receiving frame (11) or a manure guiding means similar to the corresponding end.

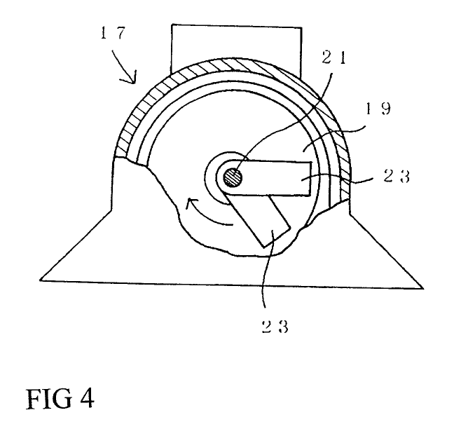

Said vibrating means 17 can be anything, but in this embodiment, as shown in FIG. 4, it is a set of weights 23 attached eccentrically to a shaft 21 of a motor 19. In this embodiment, two weights 23 are attached to the shaft 21 of the motor 19 at a certain angular distance from each other so as to be adjustable. By adjusting the angular distance of these two weights, the vibration of the vibrating means 17 is adjusted.

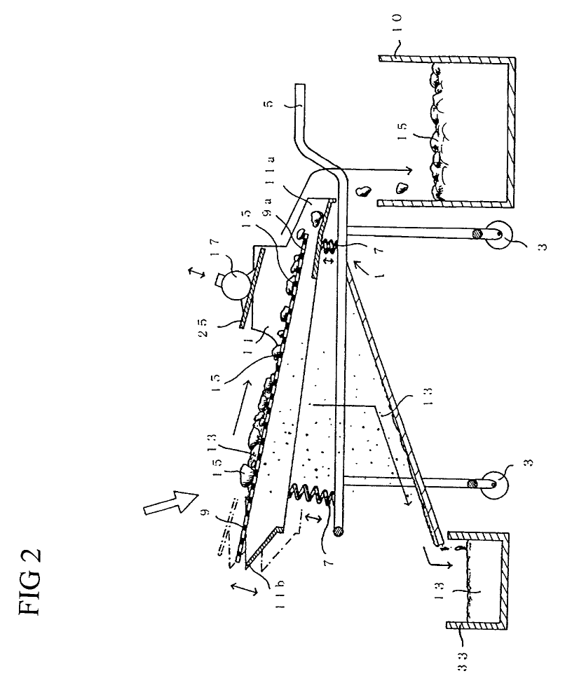

In the embodiment shown in FIG. 1 and FIG. 2, the vibrating means 17 consisting of the weights 23 attached eccentrically to the shaft 21 of the motor 19 is attached near the end 11a of the reticulated object receiving frame 11 via a flat attaching plate 25 so as to amplify the vibration.

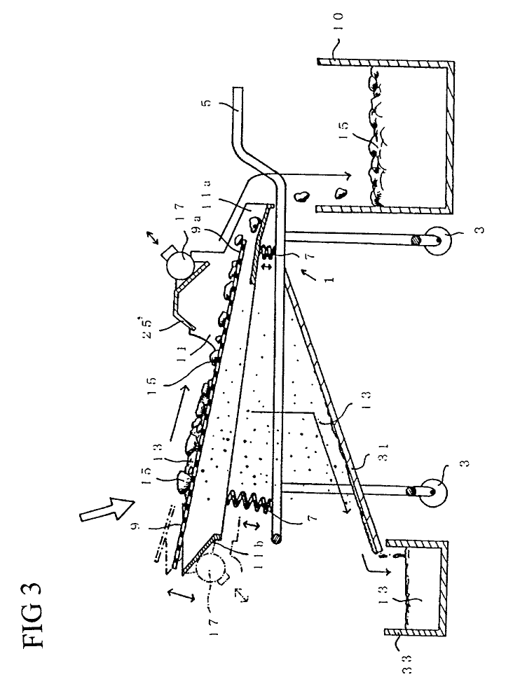

In the embodiment shown in FIG. 3, the vibrating means 17 consisting of the weights 23 attached eccentrically to the shaft 21 of the motor 19 is attached near the end 11a of the reticulated object receiving frame 11 via an angular attaching plate 25′ so as to amplify the vibration. As shown by the dotted lines in FIG. 3, the vibrating means 17 can also be attached to the other end (front end) 11b of the reticulated object receiving frame 11.

It is desirable that an inclined plate 31 is located beneath said reticulated object 9 to receive sawdust 13 falling through the holes of the reticulated object 9. Here, 33 denotes a sawdust receiving container that receives the sawdust 13 that has fallen from the inclined plate 31.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

WHAT IS CLAIMED IS:

1. A device for separating sawdust and manure, comprising a reticulated object in an inclining position connected to a supporting frame through a spring so as to be able to vibrate freely, wherein the reticulated object is vibrated by a vibrating means, such that when sawdust containing manure is placed on the inclining reticulated object when the reticulated object is vibrated, the manure falls from the lower end of the reticulated object and the sawdust passes through the reticulated object and falls beneath the reticulated object.

2. The device for separating sawdust and manure according to claim 1, wherein wheels are attached to said supporting frame for moving the device.

3. The device for separating sawdust and manure according to claim 1, wherein said vibrating means comprises a set of weights attached eccentrically to a shaft of a motor.

4. The device for separating sawdust and manure according to claim 1, wherein an inclined plate is disposed beneath said reticulated object so as to receive the sawdust passing through the reticulated object.

5. A device for separating sawdust and manure according to claim 1, wherein:
wheels are attached to said supporting frame for moving the device;
the vibrating means comprises a set of weights attached eccentrically to a shaft of a motor; and
wherein an inclined plate is disposed beneath said reticulated object so as to receive the sawdust passing through the reticulated object.
